(19) United States
(12) Patent Application Publication
(10) Pub. No.: US 2004/0037632 A1
(43) Pub. Date: Feb. 26, 2004

(54) Fitting

(76) Inventors: Holger Herth, Bad Salzuflen (DE); Oliver Link, Bad Salzuflen (DE); Georg Kaluza, Velbert (DE)

Correspondence Address: COHEN, PONTANI, LIEBERMAN & PAVANE, 551 FIFTH AVENUE, SUITE 1210, NEW YORK, NY, 10176, US

(21) Appl. No.: 10/381,127

(22) PCT Filed: Sep. 20, 2001
(86) PCT No.: PCT/EP01/10898

(30) Foreign Application Priority Data
Sep. 22, 2000 (DE) 100 47 559.0

(51) Int. Cl. F16D 1/00; B25G 3/18

(52) U.S. Cl. 403/322.4

(57) ABSTRACT

The invention relates to fittings (1, 21) for the fixing and/or locking arrangement of a glass element (45) on at least one adjacent glass element, whereby the fittings (1, 21) are composed of fitting halves (2, 3, 22, 23, 26, 27) each consisting of a substructure (42) fixed to the glass element (45) and of a covering (25) that crowns the substructure (42). The aim of the invention is to create a fitting (1, 21), which forms a compact and visually appealing unit having a smallest possible overall height, whereby retaining the existing diversity of use and the various functions. To this end, the covering (25) comprises a front surface (7, 30), which is fixed between lateral faces (5, 6, 28, 29) and which curves in a convex manner from one edge (8, 31) to the opposite edge (9, 32).

The invention concerns a fitting in accordance with the introductory clause of claim 1. Fittings of this type are used especially for mounting and/or lockably installing a glass element on at least one adjacent glass element, such that the glass elements may be rigidly or flexibly attached to one another.

The catalogue “DORMA Glass Fitting Technology, Edition September 1998” contains fittings of this type both with and without integrated locks or built-in handles. Each fitting consists of two fitting halves. Each fitting half is modularly constructed and consists essentially of a substructure, which is formed from a base and a functional insert, in which, e.g., the actual lock and/or a latch mechanism is integrated, and a cover that fits over the substructure. This provides various possibilities for joining both indoor and outdoor all-glass elements.

The dihedral angle of glass elements that are flexibly mounted on each other is limited by, among other factors, the shape of the fittings, their covers, and their handles. The angular shape of the previously known covers is a disadvantage in this respect, because their edges meet too soon and restrict the dihedral angle. Due to the formation of the edges, the covers require expensive manufacture and are less than optimum from the standpoint of the economical use of material. Furthermore, the cover can result in personal injury, especially during cleaning work.

Attachment of the covers by clips or catches is disadvantageous. Even during the initial installation, the catches can be damaged or broken off. Especially after repeated disassembly or assembly, tight seating of the cover is no longer guaranteed. In the event of excessive stress on the element, especially in the case of movable door elements, shaking and vibration can adversely affect the catch.

The goal of the invention is to develop a fitting in accordance with the introductory clause of claim 1, which forms a compact and visually pleasing unit with the smallest possible overall height and lateral extent, while retaining the previous multiplicity of use and variety of functions. In particular, it must be possible to attach the cover of the fittings securely on the substructure beneath it.

This goal is achieved by the features specified in claim 1. Advantageous modifications of the object of claim 1 are specified in the secondary claims.

The fittings of the invention in accordance with claim 1 and claim 2 have the advantage that a small overall height and compact unit can be realized as a result of the elongated cover's convex outer form, which extends in one arrow direction. The angular outer form is avoided. Accordingly, the substructure located beneath the cover is rounded, at least at the comers, so that a flat support of the cover is formed. The curvature thus allows optimum utilization of the structural space and optimization of the manufacturing expense and the material that is used.

Although the material requirement for the cover of the invention is extremely small, the stability properties and functional properties are guaranteed. In particular, the at least partially flat support of the cover on the substructure damps vibrations caused by use and thus prevents unwanted loosening of the cover.

The resulting outer contours have a visually pleasing design due to the flowing and seamless transitions. All edges and borders are provided with radii. The result is a universal, model-independent, but general, outer design line. All material thicknesses are reduced to a minimum. The flowing curve of the outer contours, especially of the front surface, significantly reduces the use of material and reduces, for example, manufacturing problems related to casting practice. Metallic materials, plastics, or so-called hybrid materials are conceivable. The color design is practically unlimited. The specified properties also contribute significantly to a reduction in production costs.

The covered arrangement of the substructure prevents inadvertent manipulations and function-inhibiting contamination and creates an advantageous visual appearance, including the aspect of transparency of the glass elements. Furthermore, there are no projecting parts, so that the cleaning of the glass surfaces is also facilitated.

The fitting can be used both for rigid attachment of a glass element, e.g., to a stationary glass element, and for flexible attachment to adjacent glass elements. The interacting fittings are designed to complement each other in such a way that they visually constitute a unit.

In the case of supporting a movable glass element on the upper side and the lower side, the fitting attached to the stationary glass element is preferably angularly designed for reasons of stability and in this way can simultaneously rigidly join a transom window and a side part with each other. The fitting attached to the movable glass element is rectangularly designed, so that the overall view is of a rectangular unit. The glass elements flexibly joined to each other by the fittings can be opened to a dihedral angle of almost 180° due to the advantageous shape of the cover.

Furthermore, a lock can be integrated in the fitting. The lock fitting is used for doors that are supported on a stationary side part or transom window made of glass and, depending on the design, can be installed on the upper side or lower side as a so-called corner lock fitting or as a normal centrally arranged lock fitting. The outer form of the fitting, i.e., the curvature of the front surface, continues in the opposing fitting. The functional insert contains at least the key-operated lock and possibly the devices for integration of a door latch. In the case of a nonglass frame, coordination with the frame structure is necessary only with respect to satisfactory function between the moving elements (latch, lock) in the lock fitting of the invention and the corresponding openings of the locking plate on the frame side. The interacting fittings are designed to complement each other in such a way that they visually constitute a unit.

In a preferred embodiment, a handle is integrated in the lock fitting, such that the lock fitting and the handle form a general outer design line that matches in an esthetic and visual sense.

The handle has the advantage that a reduction of the spatial extent is realized by the grip, which is curved in the direction of a hinged element, e.g., a door. A projecting free end of the grip is avoided. The curvature thus allows optimum utilization of the structural space and optimization of the manufacturing expense and the material that is used.

The user is given a definite sense of grip. Due to an inwardly bent or curved design of the grip, a haptically advantageous tactile surface is created, which gives the user a definite sense of grip and, especially when the user has an incomplete grasp of the grip, prevents the hand from slipping. Furthermore, the danger of catching articles of clothing or other objects on the grip is minimized, since the distance between the free end and the swiveling element is extremely small.

The handle consists of a grip, to which a connecting element is attached at one end to form a single piece. The connecting element serves the purpose of nonpositive connection with, for example, a door. The grip and the connecting element have a round cross section. The diameter of the connecting element preferably increases in the direction of the swiveling element. On the one hand, this minimizes the use of material, and, on the other hand, it ensures stable mounting of a latch pin, which mechanically connects the handle with a locking mechanism and an opposing handle.

The free end of the grip is bounded by an inclined, preferably flat, front surface, whose region facing the swiveling element is preferably farther from the connecting element than its region facing away from the swiveling element. The transitions between the front surface and the grip have radii or bevels.

The handle is advantageously manufactured in a casting process as a single piece and then finished. The flowing curve of the outer contours reduces, for example, manufacturing problems related to casting practice.

The handle and its individual parts can be manufactured from various materials, such as brass, iron, high-grade steel, aluminum, or bronze, or from other nonmetallic materials, such as plastic.

Handles in accordance with the invention may be used as door grips, window grips, or other types of grips, which are used purely as handles or may have functions relevant to locking. Uses that are relevant to locking, e.g., door or window grips, are realized principally by a handle that is operated by turning, such that the handle is coupled with the locking mechanism of the door or window.

A fitting of the invention in accordance with claim 12 has the advantage that the attachment of the cover involves no catches or clips, which are susceptible to wear and may fail, e.g., as a result of material fatigue. The realization of a partially spring-loaded mounting also makes it possible to compensate for use-related shaking or vibrations; greater tolerance compensation of the components that are used also presents no problems.

In its inside chamber for holding the substructure of the fitting, the cover has openings on one side, which interact at least by frictional resistance with locking elements preassembled in the substructure, so that the two complementarily engage each other. For the final mounting of the cover, grooves are engaged with pins that are spring-mounted in the substructure. The locking elements may be designed, e.g., as slotted pins, which are driven into bores in the substructure. In another embodiment, the locking elements are designed as so-called grub screws, which can be screwed into tapped holes.

To install the locking elements, either a striking tool or a screwdriver is needed, depending on the design. The locking elements are either formed on the substructure as a single piece during manufacture or are preinstalled in the substructure directly on site before the fitting is mounted. This also ensures that the relatively small components are not lost. The locking elements form a blockade in the openings against horizontal loads, so that it is not possible for the cover to swing out. In the event that disassembly becomes necessary, the cover is pushed as far as possible in the spring-relieving vertical direction, so that the grooves and pins can then be disengaged under a slight tensile load by swinging away the cover. On the opposite side, the connection between the openings and the locking elements can then be broken by simple vertical movement of the cover. No tools are needed either for assembly or disassembly of the cover. In this way, damage to the often sensitive surfaces of the covers and plate-shaped elements is prevented.

The externally invisible connection between the spring-supported pins and the grooves is preferably arranged on the side of the fitting facing the viewer, while the locking connections are arranged on the side of the fitting turned away from the viewer.

The invention will now be explained in greater detail on the basis of specific embodiments.

FIG. 1 shows a top view of a fitting.

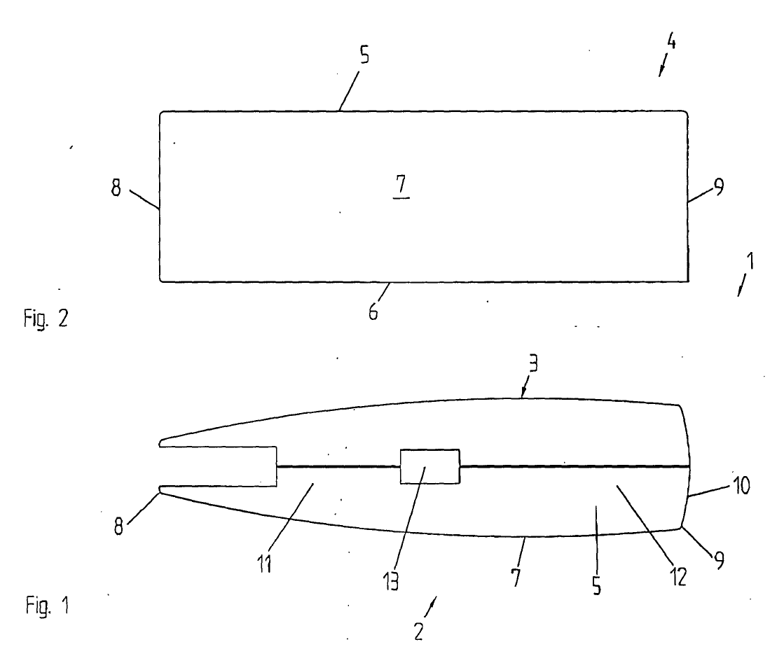

FIG. 2 shows a front view of the fitting in FIG. 1.

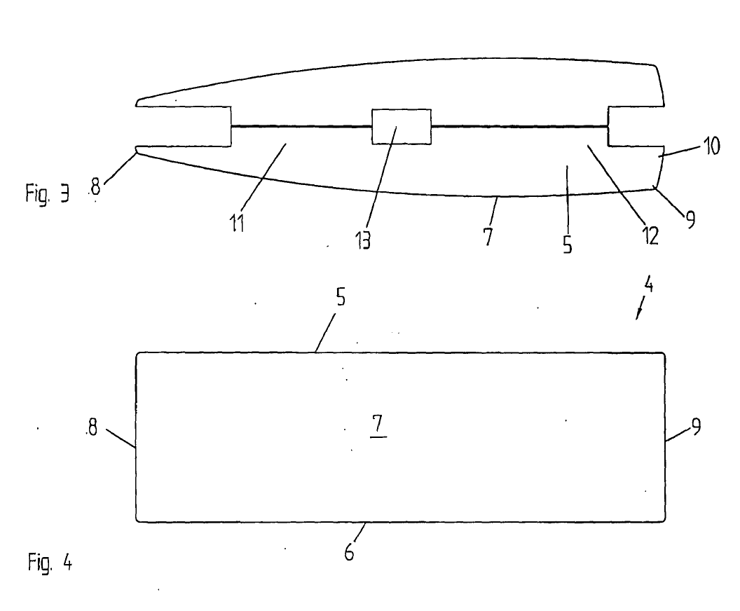

FIG. 3 shows a top view of another embodiment of a fitting.

FIG. 4 shows a front view of the fitting in FIG. 3.

FIG. 5 shows a top view of another embodiment of a fitting.

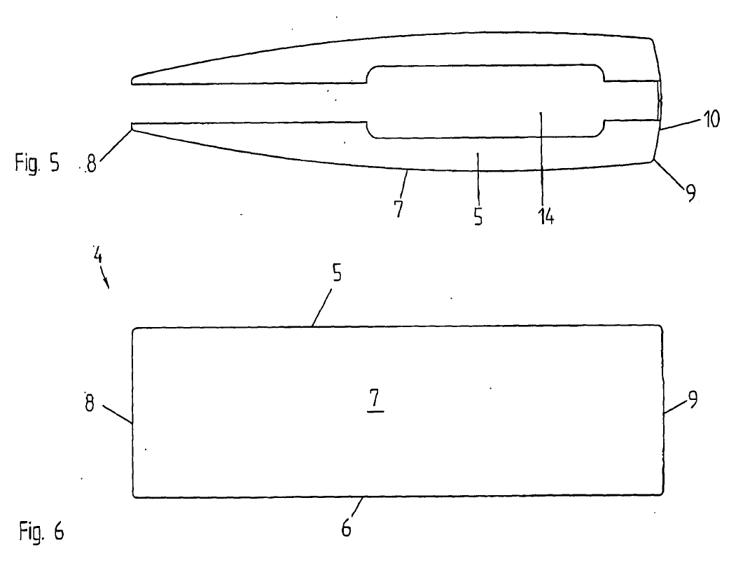

FIG. 6 shows a front view of the fitting in FIG. 5.

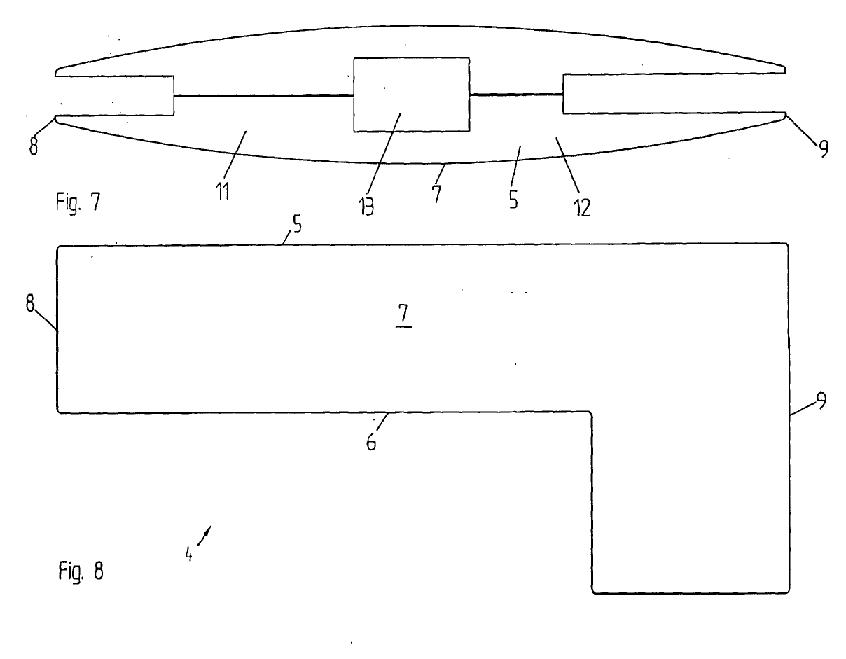

FIG. 7 shows a top view of another embodiment of a fitting.

FIG. 8 shows a front view of the fitting in FIG. 7.

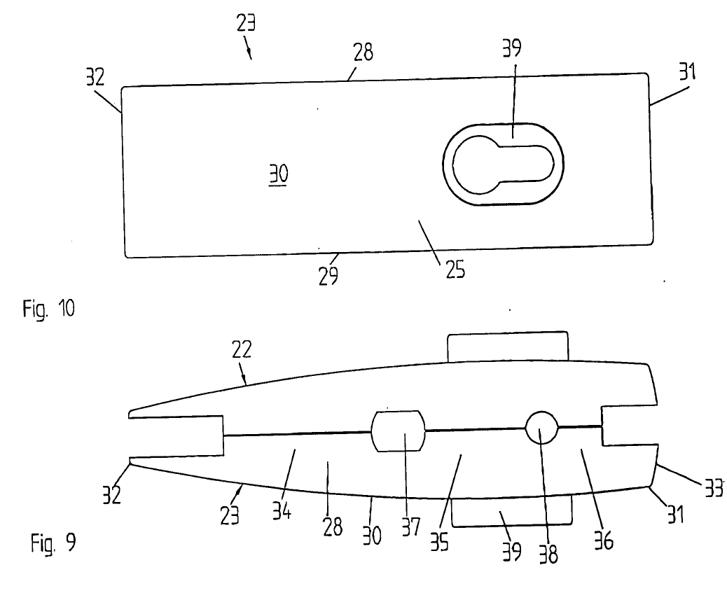

FIG. 9 shows a view of a lock fitting.

FIG. 10 shows a front view of the lock fitting in FIG. 9.

FIG. 11 shows a view of another embodiment of a lock fitting.

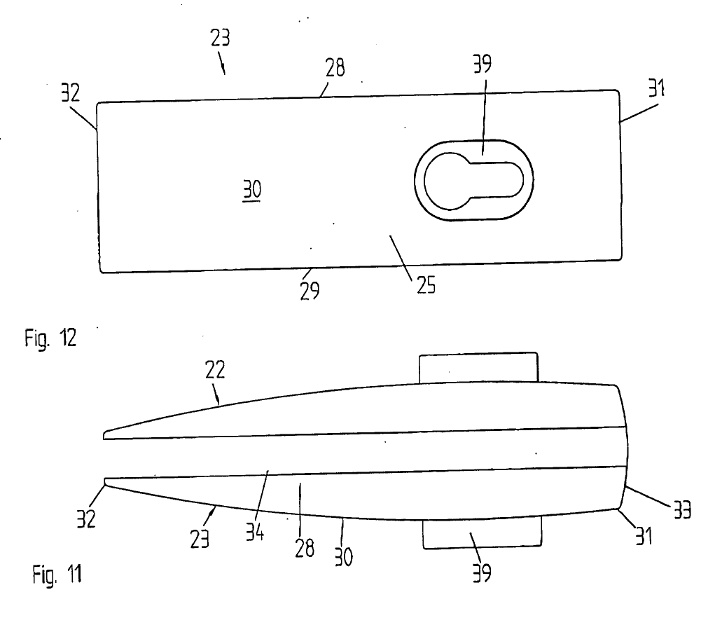

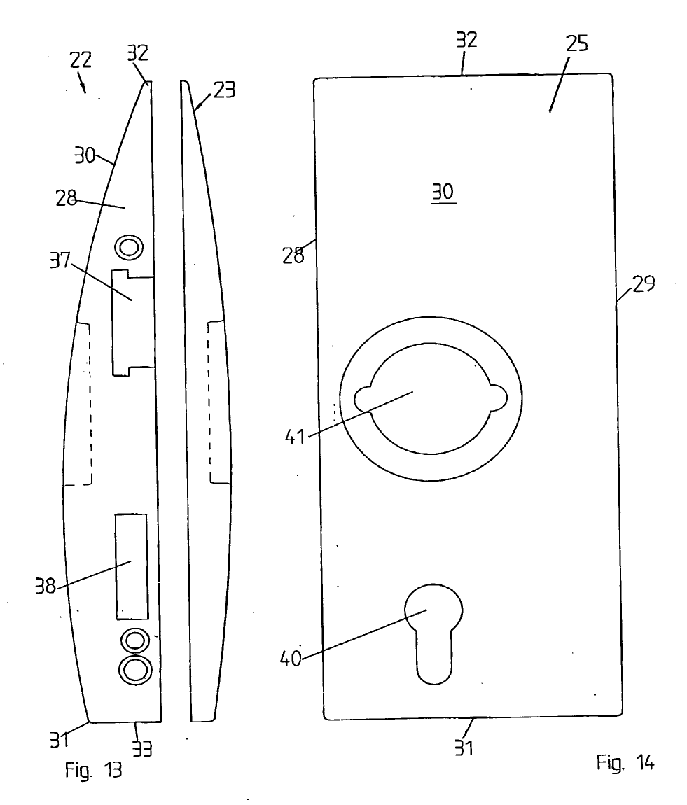

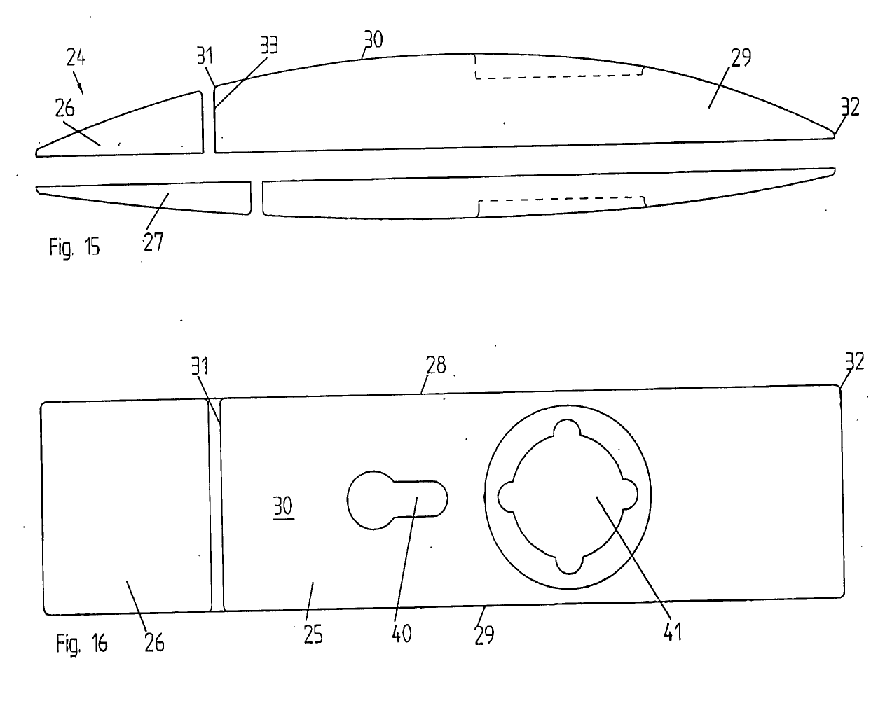

FIG. 12 shows a front view of the lock fitting in FIG. 11.

FIG. 13 shows a view of another embodiment of a lock fitting.

FIG. 14 shows a front view of the lock fitting in FIG. 13.

FIG. 15 shows a view of another embodiment of a lock fitting.

FIG. 16 shows a front view of the lock fitting in FIG. 15.

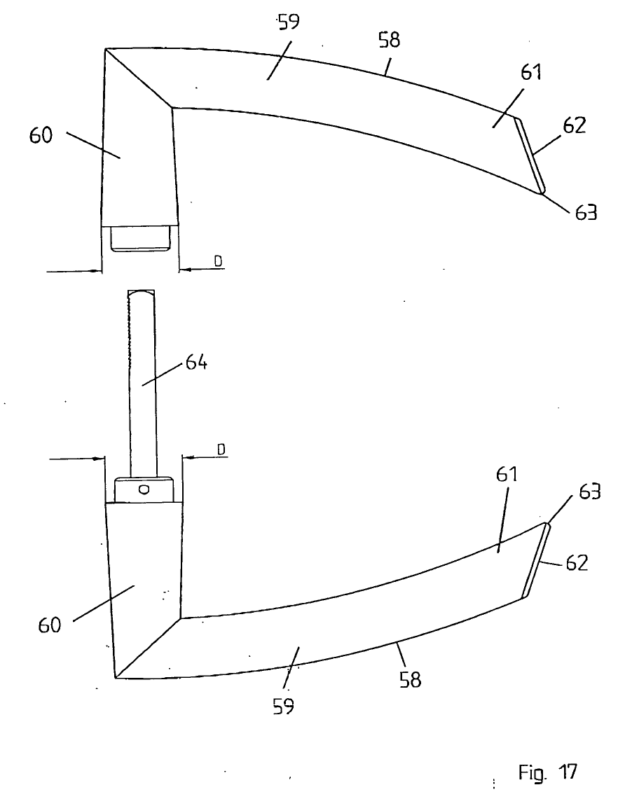

FIG. 17 shows a top view of a set of handles, which can be mounted on both sides of a swiveling element (not shown).

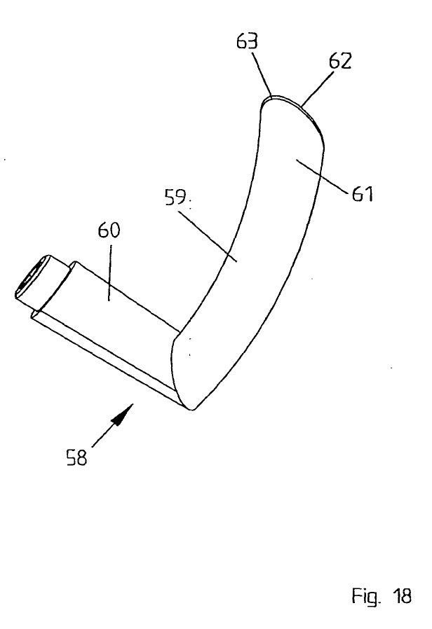

FIG. 18 shows a perspective view of a handle.

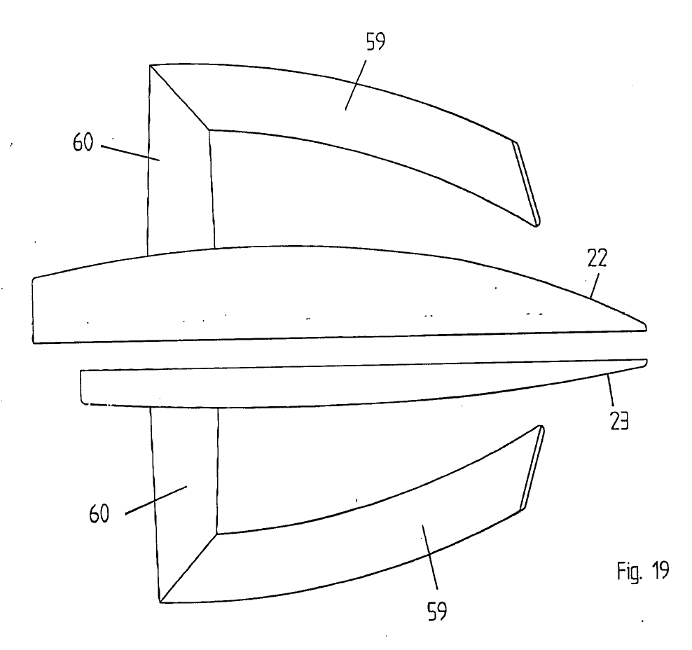

FIG. 19 shows a top view of a fitting with integrated handles.

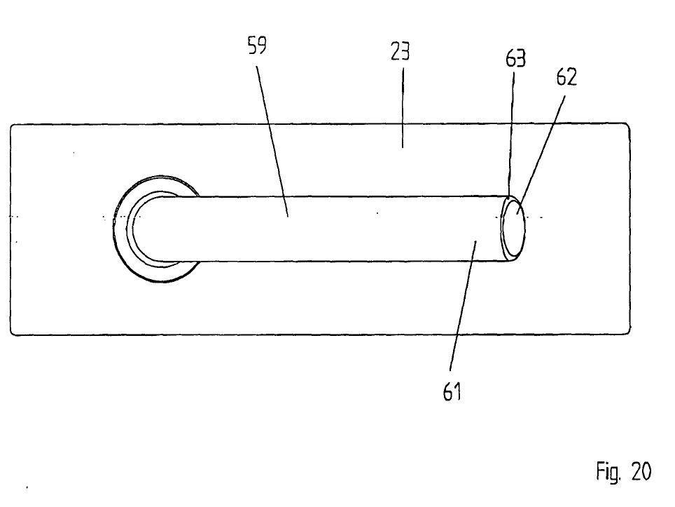

FIG. 20 shows a side view of the fitting in FIG. 19.

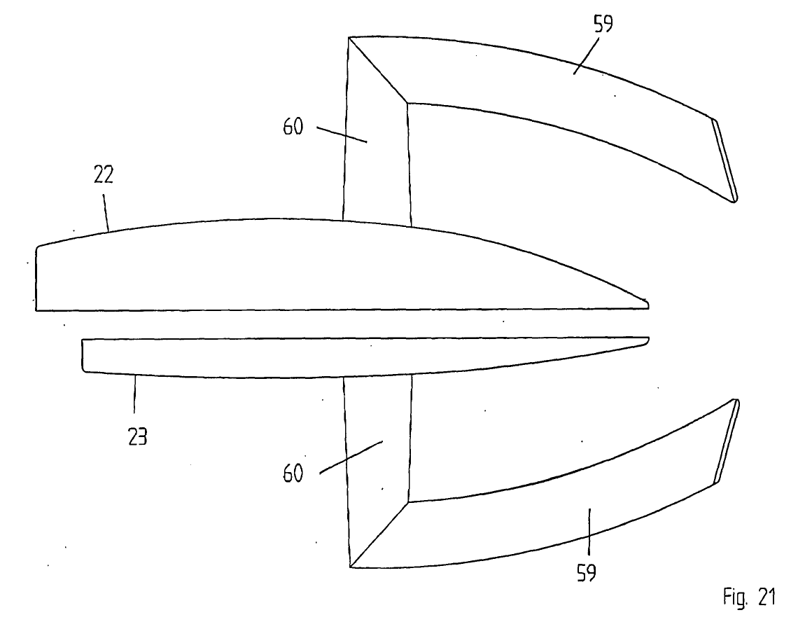

FIG. 21 shows a top view of another fitting with integrated handles.

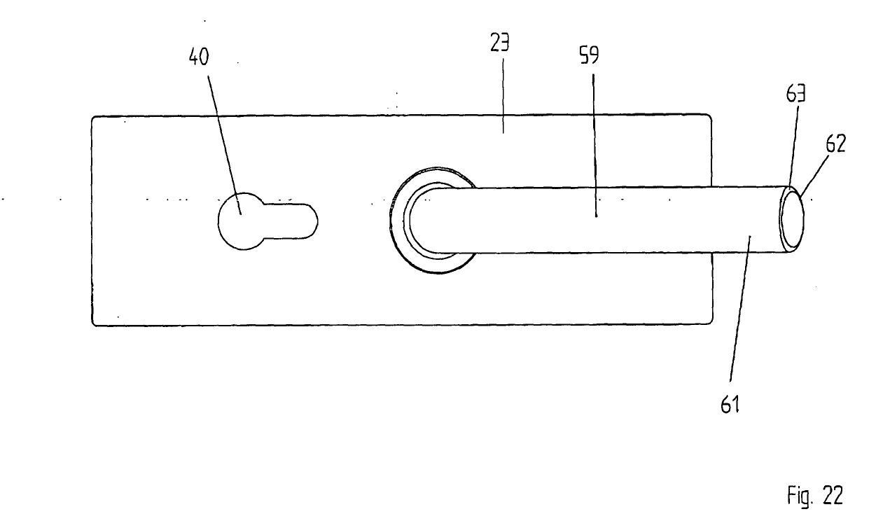

FIG. 22 shows a side view of the fitting in FIG. 21.

FIG. 23 shows a partial section of a mounted fitting in accordance with FIG. 5 and FIG. 6.

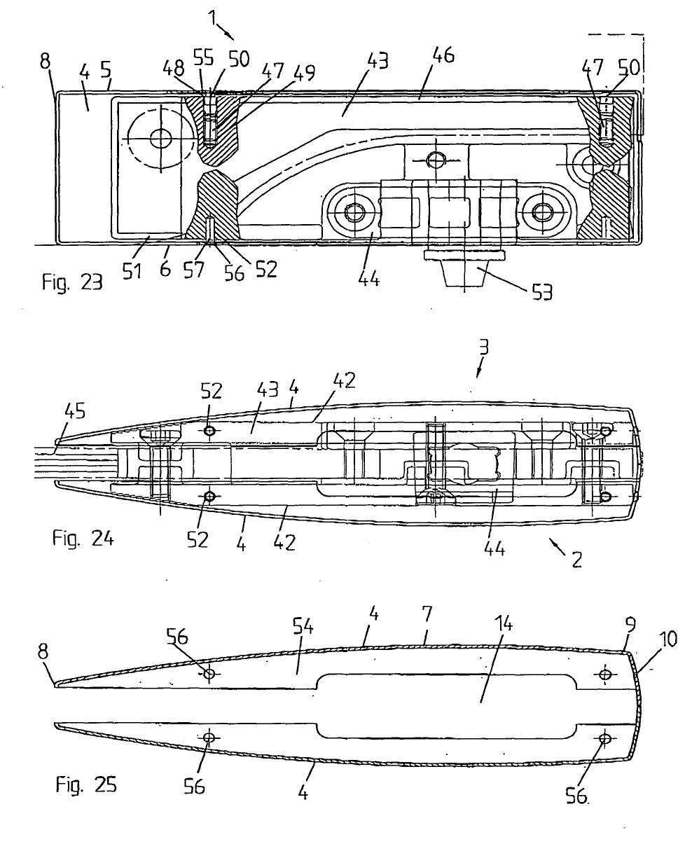

FIG. 24 shows a bottom view of the fitting in FIG. 23 mounted on a glass edge.

FIG. 25 shows a sectional view of an unmounted cover.

Components that are the same or have the same function are labeled with the same reference numbers in the following description; in particular, mirror-symmetrical components are identically labeled.

Each of the fittings 1 shown schematically in FIGS. 1 to 8 consists of mirror-symmetrical fitting halves 2 and 3, such that each fitting half 2 and 3 has a substructure 42 and a cover 4 mounted on it. The substructure 42 may be composed of a base 43 and a functional insert 44.

Fittings 1 of this type are used, e.g., for the rigid or flexible connection of glass elements in all-glass units. The glass elements have bores or openings to allow mounting of the bases 43 on both sides, preferably by clamping with screws, possibly with the intermediate insertion of a glass protector. Functional inserts 44 are then mounted on these bases 43. The functional inserts 44 may allow, for example, flexible support or rigid mounting of an adjacent glass element. This modular construction of the fitting system allows interchangeable use of bases 43, functional inserts 44, and covers 4. The glass elements may be designed, e.g., with specific colors or profiles.

The more detailed explanation and representation of the embodiments are limited below to the immediate region of the fittings 1. The substructure 42 and its base 43 and functional insert 44 are not shown, since each of them is located completely and invisibly below the respective cover 4. All of the functional elements are thus also advantageously covered, so that they are not visible.

FIGS. 1 and 2 show a first embodiment of a fitting 1 in accordance with the invention. Its fitting halves 2 and 3 and their covers 4 are shown in the installed state in a view towards the edge (not shown) of a glass element. Due to the mirror symmetry of the fitting halves 2 and 3, the following description applies to both fitting halves 2 and 3. Each cover 4 has two horizontally oriented lateral faces 5 and 6, between which a front face 7 extends from one vertical edge 8 to an opposite vertical edge 9. The cover 4 has a rectangular, elongated outer shape. The front face 7 has an outwardly directed convex curvature, which increases starting from the edge 9 shown on the right side of the drawing to the left edge 8. The right edge 9 has an angularly projecting lateral face 10, which spans a vertical edge of the glass element. This lateral face 10 is also shaped outwardly convex. At the left edge 8, the front face 7 tapers to an apex due to the greater curvature, so that a direct glass support is formed there. The lateral face 5 is partially formed on the glass edge with extensions 11 and 12, which cover the glass edge. Between the extensions 11 and 12, there is a recess 13, through which the elements connecting the functional inserts, e.g., in the form of a bearing pin, are connected.

FIGS. 3 and 4 show a modified embodiment of FIGS. 1 and 2, in which a shortened lateral face 10 is formed on the vertical glass edge. FIGS. 5 and 6 show another embodiment, in which no extensions are formed on the lateral face 5. The lateral face 5 has a recess 14, so that functional inserts can interact.

FIGS. 7 and 8 show another embodiment, which is suitable for a fitting 1, which rigidly connects a transom window and a side part and on which another glass element is flexibly supported. The components essentially correspond to those of the embodiments described above. Each fitting half 2 and 3 is additionally designed with an angled projection 15 for the stationary connection of the side part. The front face 7 is uniformly curved from one edge 8 to the opposite edge 9 and tapers to an apex at both ends directly on the surface of the glass. The lateral face 5 is likewise provided with extensions 11 and 12 and a recess 13.

Each of the lock fittings 21 shown schematically in FIGS. 9 to 16 consists of fitting halves 22 and 23, each of which has a substructure 42 and a cover 25 mounted on it. The substructure 42 consists of a base 43 and a functional insert 44.

Lock fittings 21 of this type are used, e.g., for glass elements used as doors. The glass elements are supported on a stationary glass side part or transom window. The more detailed explanation of the embodiments is always limited to one fitting half, due to the functional similarity.

FIGS. 9 and 10 show a first design of the lock fitting 21 as a so-called comer fitting, such that the lock fitting 21 is mounted at the upper and/or lower comer on the swiveling side of a glass element, which is not shown in the drawings. In this case, the glass element is designed to have a push grip in the middle of the door and is locked relative to the surrounding field by locks located in the corner fittings. The covers 25 of this lock fitting 21 are shown in the installed state in a view towards the edge (not shown) of a glass element. The covers are positioned opposite each other with mirror symmetry, and each has a rectangular, horizontally elongated outer shape. Each cover 25 has two horizontally oriented lateral faces 28 and 29, between which a front face 30 extends from one edge 31 to the other edge 32. The front face 30 has an outwardly directed convex curvature, which increases starting from the edge 31 shown on the right side of the drawing to the left edge 32. The right edge 31 has an angularly projecting lateral face 33, which spans the vertical edge of the glass element. At the left edge 32, the front face 30 tapers to an apex due to the greater curvature, so that a direct glass support is formed there. The lateral face 28 is partially formed on the glass edge with extensions 34, 35, 36, so that the glass edge is covered by them. Between the extensions 34, 35, 36, there are recesses 37, 38, through which the elements located in the functional inserts, e.g., in the form of a locking bolt, can be passed. The front face 30 of the cover 25 has a projection 39, by which the lock (not shown) is covered.

FIGS. 11 and 12 show a modified embodiment of FIGS. 21 and 22, so that the lock fitting 21 can also be used in the middle of a door. Therefore, no extensions are formed on the lateral faces 28 and 29. The locking bolt is locked horizontally here.

FIGS. 13 and 14 show a design of the lock fitting 21 of the invention as a center fitting, such that the lock fitting 21 is mounted preferably in the middle on the swiveling side of a glass element. In this case, the lock fitting 21 can have a door latch, which is not shown in the drawings, with a latch and a lock with a bolt, which work together with corresponding fittings of a locking plate (not shown). The covers 25 of this lock fitting 21 are shown in the installed state in a view towards the vertical edge (not shown) of a glass element. Each of the covers 25 has a rectangular, vertically elongated outer shape. Each cover 25 has two vertically oriented lateral faces 28 and 29, between which a front face 30 extends from one horizontal edge 31 to the opposite horizontal edge 32. The front face 30 has an outwardly directed convex curvature, which increases starting from the edge 31 at the bottom of the drawing to the upper edge 32. The lower edge 31 has an angularly projecting lateral face 33, which rests on the surface of the glass element. At the upper edge 32, the front face 30 tapers to an apex due to the greater curvature, so that a direct glass support is formed there. The lateral face 29 contains recesses 37 and 38, through which the elements located in the functional inserts, e.g., in the form of a latch and a locking bolt, can be passed. In the front face 30, there are openings 40 and 41, through which the lock can be operated by a door latch. The opposing half 23 of the fitting has the same shape but is considerably flatter in design.

FIGS. 15 and 16 show a design of the lock fitting 21 of the invention as a center fitting with horizontal orientation, such that the lock fitting 21 is mounted preferably in the middle on the swiveling side of a glass element. In this case, the lock fitting 21 has a door latch with a latch and a lock with a bolt, which work together with corresponding holding fixtures of an opposing fitting installed in a side part. The fitting halves 26 and 27 of the opposing fitting 24 are also shown and produce an ergonomic unit in continuation of the curved shape of the fitting halves 22 and 23 of the lock fitting 21. The covers 25 lie opposite each other, and each has a rectangular, horizontally elongated shape. Each cover 25 has two horizontally oriented lateral faces 28 and 29, between which a front face 30 extends from one vertical edge 31 to the other edge 32. The front face 30 has an outwardly directed convex curvature, which increases starting from the edge 31 shown on the left side of the drawing to the right edge 32. The left edge 31 has an angularly projecting lateral face 33. At the right edge 32, the front face 30 tapers to an apex due to the greater curvature, so that a direct glass support is formed there. In the lateral edges 33 on the frame side, there are recesses 37 and 38, through which the elements located in the functional inserts, e.g., in the form of a latch and a locking bolt, can be passed horizontally. The opposing fitting 24 installed in the side part follows in its shape the lateral face 33 of the lock fitting 21 and tapers to the surface of the side part. In this way, the whole fitting forms a unit and has a uniform curvature of the entire front face 30.

A handle 58, which can be inserted in the functional insert of a lock fitting 21, is shown in FIGS. 17 to 22.

The handle 58 consists essentially of a grip 59 and a connecting element 60, which is installed as a single piece at one end and produces the nonpositive locking connection to a swiveling element (not shown), such as a door or its fitting. Both the grip 59 and the connecting element 60 have a round cross section. The handles 58 are made of high-grade steel, bronze, brass, or some other metal.

The embodiment shown in FIG. 17 is a set of two handles 58, which can be mounted on both sides of a swiveling element. The handles 58 are identical and can be mounted mirror-symmetrically to each other. Each grip 59 is curved convexly and sloped inward along its whole length. This results in a grip shape that corresponds to the natural shape of the hand, so that an advantageous tactile sense is assured. The grip 59 is designed without contours and has a uniformly round cross section.

The free end 61 of the grip 59 is bounded by an inclined, preferably flat end face 62, whose region near the swiveling element is farther from the connecting element 60 than its region farther from the swiveling element. The transitions between the end face 62 and the grip 59 have either bevels or radii 63.

The grip 59 makes the angular transition into the connecting element 60 as a single piece and at an angle of less than 90°. This creates the inwardly directed slope of the grip 59. The connecting element 60 is unprofiled and has a round cross section. The diameter D of the connecting element 60 preferably increases, starting at the grip 59. A latch pin 64 is installed in the connecting element 60 for connecting the handle 58 mechanically with a locking mechanism and/or an opposing handle 58.

FIGS. 19 and 20 show a design of the fitting 21 as a center fitting with a horizontal orientation, such that the fitting 21 is preferably mounted in the middle on the swiveling side of a glass element. In this case, the handle 58 of the invention is integrated in the fitting and operates a latch by means of a locking mechanism installed inside the fitting 21. The latch works together with the corresponding holding fixtures of an opposing fitting (not shown) installed in a side part. The fitting halves of the opposing fitting produce an ergonomic unit in continuation of the curved shape of the fitting halves 22 and 23.

The fitting 21 shown in FIGS. 21 and 22 differs from the fitting 21 shown in FIGS. 19 and 20 only in that a lock can be additionally inserted into a corresponding opening 40. By means of the locking mechanism installed in the fitting 21, a key, which can be inserted in the lock, operates a latch, which engages a corresponding recess in the opposing fitting.

The basic design of a fitting 1 is described in greater detail on the basis of FIGS. 23 to 25. The design of a lock fitting 21 differs from it only by the integration of a lock and/or a handle. The fitting 1 consists of mirror-symmetrical fitting halves 2 and 3, each of which has a substructure 42 and a cover 4 mounted on it. The substructure consists of a base 43 and a functional insert 44.

As was described earlier, fittings 1 of this type are used for the rigid or flexible connection of all-glass elements 45 in all-glass units. The glass elements 45 have bores or openings to allow mounting of the bases 43 on both sides, preferably by clamping with screws, possibly with the intermediate insertion of a glass protector. Functional inserts 44 are then mounted on these bases 43. The functional inserts 44 may allow, for example, flexible support or rigid mounting of a glass element 45. This modular construction of the fitting system allows interchangeable use of bases 43, functional inserts 44, and covers 4. The glass elements may be designed, e.g., with specific colors or profiles.

The base 43 has a flat and basically rectangular design, and, on its upper longitudinal side 46 shown in FIG. 17, it has two vertically inwardly directed blind holes 47, which are spaced some distance apart and are narrowed towards the outside by a constriction 48. Each blind hole 47 contains a spring 49, which presses a stepped pin 50 against the constriction 48, so that the pin 50 is captively positioned in the blind hole 47. When the spring 49 is in its relaxed state, the pin 50 extends beyond the surface of the longitudinal side 46. In the lower longitudinal side 51 shown in FIG. 17, the base 43 has two vertically inwardly directed bores 52, which are spaced some distance apart. The bores 52 are axially aligned with the blind holes 47.

Each cover 4 has two horizontally oriented lateral faces 5 and 6, between which a front face 7 extends from one vertical edge 8 to an opposite vertical edge 9. The cover 4 has a rectangular outer shape. The front face 7 has an outwardly directed convex curvature, which increases starting from the edge 9 towards the edge 8. The right edge 9 has an angularly projecting lateral face 10, which spans a vertical edge of the glass element 45. At the edge 8, the front face 7 tapers to an apex due to the greater curvature, so that a direct glass support is formed there. The lateral face 5 is provided with a recess 14 at the edge of the glass, through which the elements connecting the functional inserts 44, e.g., in the form of a bearing pin 53, are connected.

Between the front face 7, the lateral faces 5 and 6, and the edges 8 and 9, a receiving chamber 54 is formed on the inside, under which the base 43 completely disappears after assembly. The lateral face 5 has two grooves 55 spaced some distance apart on the inside. The lateral face 6 is penetrated by two openings 56 spaced some distance apart.

Before the substructure 42 is mounted on the glass element 45, locking elements 57 in the form of grooved pins are driven into the bores 52, so that they are frictionally engaged. In accordance with an embodiment that is not shown in the drawings, the locking elements 57 can be formed on the substructure 42 as a single piece during manufacture. After the subsequent mounting of the substructure 42, the lateral face 6 of the cover 4 is set obliquely on the longitudinal side 51 of the base 43, so that the openings 56 are engaged with the locking elements 57 to provide positive locking. In the subsequent tilting movement of the cover 4 in the direction of the glass element 45, the receiving chamber 54 is completely inverted over the substructure 42. During this operation, the pins 50 are pushed back into their blind holes 47 by the action of the springs. Under the action of the springs 49, when the appropriate final alignment of the cover 4 is achieved, the pins 50 are pressed into the corresponding grooves 55. In this position, the cover 4 is fixed for the time being. The procedures described above are carried out on both sides of the glass element.

A possible disassembly is carried out in the reverse order. In this case, the cover is pushed as far as possible in the spring-relieving vertical direction, so that the grooves 55 and pins 50 can then be disengaged under a slight tensile load by swinging away the cover 4. On the lateral face 6, the connection between the openings 56 and the locking elements 57 can then be broken by simple vertical movement of the cover 4.

List of Reference Numbers

1 fitting

2 fitting half

3 fitting half

4 cover

5 lateral face

6 lateral face

7 front face

8 edge

9 edge

10 lateral face

11 extension

12 extension

13 recess

14 recess

15 extension

21 lock fitting

22 fitting half

23 fitting half

24 opposing fitting

25 cover

26 half of opposing fitting

27 half of opposing fitting

28 lateral face

29 lateral face

30 front face

31 edge

32 edge

33 lateral face

34 extension

35 extension

36 extension

37 recess

38 recess

39 projection

40 opening

41 opening

42 substructure

43 base

44 functional insert

45 glass element

46 longitudinal side

47 blind hole

48 constriction

49 spring

50 pin

51 longitudinal side

52 bore

53 bearing pin

54 receiving chamber

55 groove

56 opening

57 locking element

58 handle

59 grip

60 connecting element

61 free end

62 end face

63 radius

64 latch pin

D diameter of the connecting element

1. Fitting for the rigid and/or flexible mounting of a glass element on at least one adjacent glass element, such that the fitting (1) consists of fitting halves (2, 3), each of which consists of a substructure (42) mounted on the glass element (45) and a cover (4) that fits over the substructure (42), characterized by the fact that the cover (4) has a front face (7) that extends between horizontally oriented lateral faces (5, 6) and runs with convex curvature from a vertical edge (8) to the opposite vertical edge (9).

2. Lock fitting, which interacts with an opposing fitting (24), such that the lock fitting (21) and the opposing fitting (24) consist of fitting halves (22, 23, 26, 27), each of which consists of a substructure (42) that has at least one lock and is mounted on the glass element (45) and of a cover (25) that fits over the substructure (42), characterized by the fact that the cover (25) has a front face (7) that extends between lateral faces (28, 29), runs with convex curvature from one edge (31) to the opposite edge (32), and has projections (39) and/or openings (40, 41).

3. Fitting in accordance with claim 1 or claim 2, characterized by the fact that the curvature is nonuniform or uniform.

4. Fitting in accordance with any of claims 1 to 3, characterized by the fact that at least one edge (9, 31) has an angled lateral face (10, 33), whose outer surface is curved.

5. Fitting in accordance with any of claims 1 to 4, characterized by the fact that the cover (4, 25) tapers to an apex at least at the edge (8, 32).

6. Fitting in accordance with any of claims 1 to 5, characterized by the fact that at least one lateral face (5, 28, 29) has extensions (11, 12, 34, 35, 36).

7. Fitting in accordance with any of claims 1 to 6, characterized by the fact that the lateral faces (5, 6, 28) and/or the extensions (11, 12, 34, 35, 36) have recesses (13, 14, 37, 38).

8. Fitting in accordance with any of claims 1 to 7, characterized by the fact that the cover (4, 25) is rectangular in design.

9. Fitting in accordance with any of claims 1 to 7, characterized by the fact that the cover (4) is designed with an L-shape and has an angled projection (15).

10. Fitting in accordance with any of claims 1 to 9, characterized by the fact that the cover (4, 25) rests at least partially flat on the substructure (42).

11. Fitting in accordance with any of claims 1 to 10, characterized by the fact that the cover (4, 25) consists of a metallic material, a plastic, or a hybrid material.

12. Fitting in accordance with any of claims 1 to 11, characterized by the fact that the cover (4) can be spring-mounted and can be mounted at least by frictional resistance on the substructure (42).

13. Fitting in accordance with any of claims 1 to 12, characterized by the fact that the substructure (42) has at least two inwardly directed blind holes (47), which are spaced some distance apart and have a constriction (48) towards the outside.

14. Fitting in accordance with claim 13, characterized by the fact that a stepped pin (50) is installed in the blind hole (47) between a spring (49) and the constriction (48).

15. Fitting in accordance with any of claims 1 to 14, characterized by the fact that the substructure (42) has at least two outwardly directed locking elements (57) spaced some distance apart.

16. Fitting in accordance with claim 15, characterized by the fact that the locking elements (57) can be inserted in bores.

17. Fitting in accordance with claim 15 or claim 16, characterized by the fact that the blind holes (47) and the locking elements (57) are formed on opposite longitudinal sides (46, 51) of a rectangular substructure (42) and are oriented in axial alignment with each other.

18. Fitting in accordance with any of claims 1 to 17, characterized by the fact that the cover (4) has at least two grooves (55) spaced some distance apart on the inside.

19. Fitting in accordance with any of claims 1 to 18, characterized by the fact that the cover (4) has at least two openings (56) spaced some distance apart.

20. Fitting in accordance with any of claims 15 to 19, characterized by the fact that the locking elements (57) and the openings (56) can be arranged in alignment with each other.

21. Fitting in accordance with any of claims 18 to 20, characterized by the fact that the grooves (55) and the openings (56) are formed on opposite lateral faces (5, 6) of a rectangular cover (4).

22. Fitting in accordance with any of claims 1 to 21, characterized by the fact that the substructure (42) consists of a base (43) and a functional insert (44).

23. Fitting in accordance with any of claims 1 to 22, characterized by the fact that the fitting halves (2, 3, 22, 23, 26, 27) are designed with mirror symmetry towards each other.

24. Lock fitting in accordance with any of claims 2 to 23, characterized by the fact that handles and/or locks can be mounted in the substructure (42).

25. Lock fitting in accordance with any of claims 2 to 24, characterized by the fact that the lateral faces (28, 29) run horizontally, and the edges (31, 32) run vertically.

26. Lock fitting in accordance with any of claims 2 to 24, characterized by the fact that the lateral faces (28, 29) run vertically, and the edges (31, 32) run horizontally.

27. Lock fitting in accordance with any of claims 2 to 26, characterized by the fact that the opposing fitting (24) continues the curvature of the lock fitting (21).

28. Lock fitting in accordance with claim 24, characterized by the fact that the handle (58) consists of a grip (59) and a connecting element (60) that can be mounted on it with nonpositive locking, such that the grip (59) is convexly curved and inwardly sloped, and that at least the grip (59) has a round cross section.

29. Lock fitting in accordance with claim 28, characterized by the fact that the grip (58) has a uniform or nonuniform convex curvature.

30. Lock fitting in accordance with claim 28 or 29, characterized by the fact that a free end (61) of the grip (58) is not angled.

31. Lock fitting in accordance with any of claims 28 to 30, characterized by the fact that the free end (61) has an inclined end face (62).

32. Lock fitting in accordance with any of claims 28 to 31, characterized by the fact that the end face (62) has radii (63) or bevels.

33. Lock fitting in accordance with any of claims 28 to 32, characterized by the fact that the connecting element (60) has a round cross section.

34. Lock fitting in accordance with any of claims 28 to 33, characterized by the fact that the diameter (D) of the connecting element (60) increases, starting at the grip (58).

35. Lock fitting in accordance with any of claims 28 to 34, characterized by the fact that the grip (58) and the connecting element (60) consist of high-grade steel.

36. Lock fitting in accordance with any of claims 28 to 35, characterized by the fact that the grip (59) and the connecting element (60) consist of bronze.

37. Lock fitting in accordance with any of claims 28 to 36, characterized by the fact that the grip (59) and the connecting element (60) consist of brass.

38. Lock fitting in accordance with any of claims 28 to 37, characterized by the fact that the grip (59) and the connecting element (60) consist of aluminum.

39. Lock fitting in accordance with any of claims 28 to 38, characterized by the fact that the grip (59) and the connecting element (60) consist of precision castings.

40. Lock fitting in accordance with any of claims 28 to 39, characterized by the fact that the grip (59) and the connecting element (60) consist of compression castings.

41. Lock fitting in accordance with any of claims 28 to 40, characterized by the fact that the handle (58) can be mounted on one or both sides on door elements, window elements, or other swiveled elements.

42. Lock fitting in accordance with any of claims 28 to 41, characterized by the fact that the handle (58) can be mounted in integrated form in fitting halves (22, 23) and opposing fittings.
